(19) United States
(12) Patent Application Publication
(10) Pub. No.: US 2011/0173221 A1
(43) Pub. Date: Jul. 14, 2011

(54) CALENDAR EXPAND GRID

(75) Inventors: Michael James Ahiakpor, Alamo, CA (US); Benjamin Richard Vincent, San Francisco, CA (US)

(73) Assignee: MICROSOFT CORPORATION, Redmond, WA (US)

(21) Appl. No.: 12/686,605

(22) Filed: Jan. 13, 2010

(51) Int. Cl. G06F 17/30

(52) U.S. Cl. 707/769; 707/802; 707/E17.044; 707/E17.108; 715/760

(57) ABSTRACT

A system and methods for enabling a mobile device to display multiple calendar views. In particular, a system allows a mobile device to switch between an agenda view, an expanded calendar view and a collapsed busy time view. Temporary free time records and event summary records are provided to the mobile device receiving input from the mobile device to view a calendar displaying the free time the user has within a selected day. Event records associated with the user for the selected day are identified in a database. The system determines remaining time slots in the selected day that are not associated with a scheduled event. A temporary free-time record is generated for each such time slot. Temporary event summary records are generated representing consecutively scheduled and solo events. The temporary free-time records and temporary event summary records are delivered to the mobile device.

### BACKGROUND

Web-based calendar applications allow users to have remote access to their schedules. For example, a user may access and view their schedule by launching a browser application on their desktop computer, laptop computer, mobile device, etc. Users often initially schedule their meetings and appointments (each also referred to as an “event”) using their personal computer (e.g., desktop computer, laptop computer) due to the high-speed Internet connections and larger screens for viewing content. Events are stored online, meaning that the calendar can be viewed from any location that has Internet access. After scheduling an event and saving it to their web-based calendar, users frequently want to check their calendars remotely via a mobile device (e.g., smart phone) while on the go. Users also want to be able to remotely schedule follow up appointments.

Web applications exist today (e.g., Microsoft's Windows Live™ Calendar Mobile Browse) that provide user's remote access to a web-based calendar via their mobile device. These web applications allow users to view their schedules by day, week, and month via their mobile device. Mobile devices have small display screens. Viewing a daily calendar on a mobile device display screen often requires scrolling up and down through the day view in order to see all the events scheduled for the day. Some web applications allow a user to view a day or week of their calendar in an “agenda view,” which displays only the events scheduled for the day. The agenda view may also display the free time slots in the day in a condensed view (e.g., “10:00 a-1:00 p Free Time”).

### SUMMARY

The technology presented is a system for enabling a mobile device to display multiple calendar views. One aspect of the system allows a mobile device to switch between an agenda view, a second view that displays the events scheduled for the day and each free time slot, and a third view that displays free time slots in the day as well as summary of events scheduled for the day. Temporary free time records and summary records are provided to the mobile device upon receiving input from the mobile device to view a calendar displaying the free time the user has within a selected day. Event records associated with the user for the selected day are identified in a database. The system determines remaining time slots in the selected day that are not associated with a scheduled event. A temporary free-time record is generated for each such time slot. Temporary summary records are generated representing consecutively scheduled events and each solo event. The temporary free-time records and temporary event summary records are delivered to the mobile device.

In some embodiments, time slots of a day are either thirty-minutes or one hour and begin and end either at the top of an hour or the bottom of an hour. In this instance, when input is received from a mobile device that a user of the device wants to view the free time the user has remaining for a selected day, the system identifies event records associated with the user for the selected day. Remaining free time slots associated with the selected day are identified, and the system automatically generates a temporary free-time record for each free time slot. The system also automatically generates temporary event summary records representing consecutive events scheduled for the day. The temporary free-time records and temporary event summary records are delivered to the mobile device, enabling the device to display a summary of scheduled events as well as free time left in the day.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a block diagram illustrating an embodiment of a system for providing web-based calendar events to a mobile device.

FIG. 2 is a block diagram illustrating an embodiment of a mobile device, such as a cellular telephone.

FIG. 3 is a processing system suitable for use in the systems described with respect to FIG. 1.

FIG. 4 is a flow chart describing one embodiment of a process for providing web-based calendar events to a mobile device.

FIG. 5 is an embodiment of exemplary event records stored in a calendar database.

FIG. 6 is a flow chart describing one embodiment of a process for displaying web-based calendar events in a mobile device.

FIG. 7A is an embodiment of a user interface providing an exemplary compressed calendar view.

FIG. 7B is a user interface providing another embodiment of a compressed calendar view.

FIG. 8 is a flow chart describing one embodiment of a process for providing an expanded calendar view.

FIG. 9 is an embodiment of a user interface providing an exemplary expanded calendar view.

FIG. 10 is a user interface displaying another compressed calendar view.

FIG. 11 is a flow chart describing one embodiment of a process for providing a compressed events view.

FIG. 12 is a user interface displaying an embodiment of a compressed events view.

FIG. 13 is a flow chart describing one embodiment of a process for scheduling a new event.

FIG. 14 is an embodiment of an exemplary new event interface.

### DETAILED DESCRIPTION

The technology described herein relates to a system for enabling a mobile device to display multiple calendar views. In particular, the system allows a mobile device to switch between an agenda view, an expanded calendar view and a collapsed busy time view. An agenda view displays only events scheduled for the day. An expanded calendar view displays each of the events scheduled for the day as well as free time slots remaining in the day. A collapsed busy time view displays the free time slots in the day and the events scheduled for the day in a condensed view. These views allow a user to easily and quickly view either their events scheduled for the day or the free time remaining in the day.

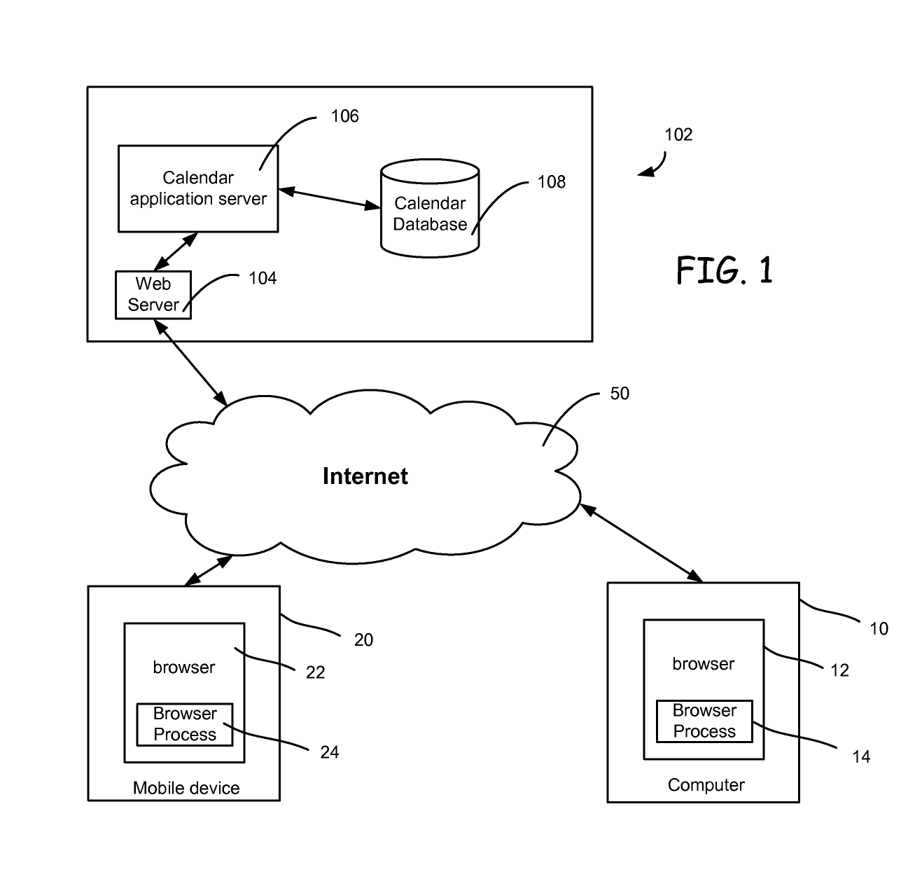

The present system will now be described with reference to FIGS. 1-14. FIG. 1 illustrates a block diagram of system 102 for providing calendar information or events to a user via the user's mobile device 20. System 102 allows a user to access, obtain and view calendar information (e.g., scheduled events) on their mobile device 20. FIG. 1 illustrates that users may connect to system 102 via a mobile phone 20 or computer 10 through the network 50 (shown as the Internet). The devices shown in FIG. 1 are exemplary only, and are not intended to limit the scope of the technology described herein. A user may use other devices to access system 102 such as, but not limited to, a laptop computer, a personal digital assistant, smart phone, and the like.

System 102 includes web server 104, calendar application server 106 and calendar database 108. Web server 104 delivers calendar web pages (e.g., HTML documents) and associated content (e.g. images, style sheets, JavaScripts) to browser 22 on mobile device 20 and web browser 12 on computer 10. Computer 10 accesses web server 104 via web browser 22 (e.g., Microsoft's Internet Explorer™). Mobile device 20 accesses web server 104 via web browser 22 (e.g., Microsoft's Internet Explorer Mobile™). Any browser known in the art today such as, but not limited to, Symbian™, Safari™, Android™, Blackberry™, NetFront™, and Opera Mobile™, may be used by mobile device 20 or computer 10 to access web server 104.

A user may schedule an event through either computer 10 or mobile device 20, which will be stored in calendar database 108. For example, a user may access a web-based calendar (e.g., Microsoft's Window Live Calendar™) by launching browser 12, 22, which communicates with web server 104 via Internet 50. Using the web UI, the user schedules an event (e.g., breakfast at Tiffany's on Oct. 28, 2009 between 9:00 am and 10:10 am). The scheduled event is stored in calendar database 108. In some embodiments, the scheduled event is stored as a calendar record (described in more detail in reference to FIG. 5). Web-based calendars generally allow a user to schedule events and access their calendar remotely. Web-based calendars are known in the art and therefore, no additional description herein is required.

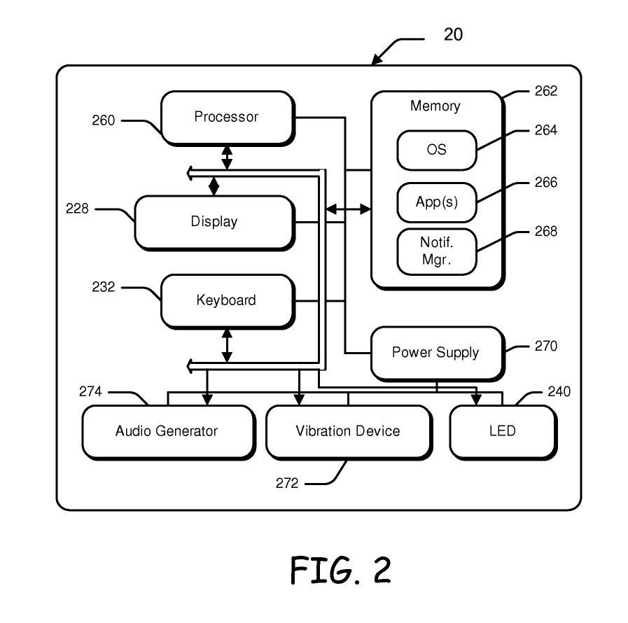

FIG. 2 shows the functional components of typical handheld computing device 220, which include processor 260, memory 262, display 228, and keyboard 232. For example, computing device 220 can be used to implement mobile device 20 of FIG. 1. The memory 262 generally includes both volatile memory (e.g., RAM) and non-volatile memory (e.g., ROM, PCMIA cards, etc.). An operating system 264 is resident in the memory 262 and executes on the processor 260.

One or more application programs 266 are loaded into memory and run on the operating system 64. Examples of applications includes email programs, scheduling programs, personal information management (“PIM”) programs, word processing programs, spreadsheet programs, browser program, and so forth. Mobile device 20 includes a notification manager 268 loaded into memory 262, which executes on processor 260. The notification manager handles notification requests from the applications 266.

Mobile device 20 also includes a power supply 270, which is preferably implemented as one or more batteries. The power supply might further include an external power source that overrides and/or re-charges the built-in batteries, such as an AC adaptor, or a powered docking cradle.

Mobile device 20 is shown with three types of notification mechanisms: an LED 240, a vibration device 272, and an audio generator 274. These devices are directly coupled to the power supply 270 such that when activated, they remain on for a duration dictated by the notification mechanism even though the processor and other components might be shut down to conserve battery power. For example, the LED 240 is often configured to remain on indefinitely until a user takes action on the notification since the LED is a low power user. The vibration generator and audio generator, however, typically consume more power, and may therefore be configured to turn off after some limited duration, or when other system components are turned off.

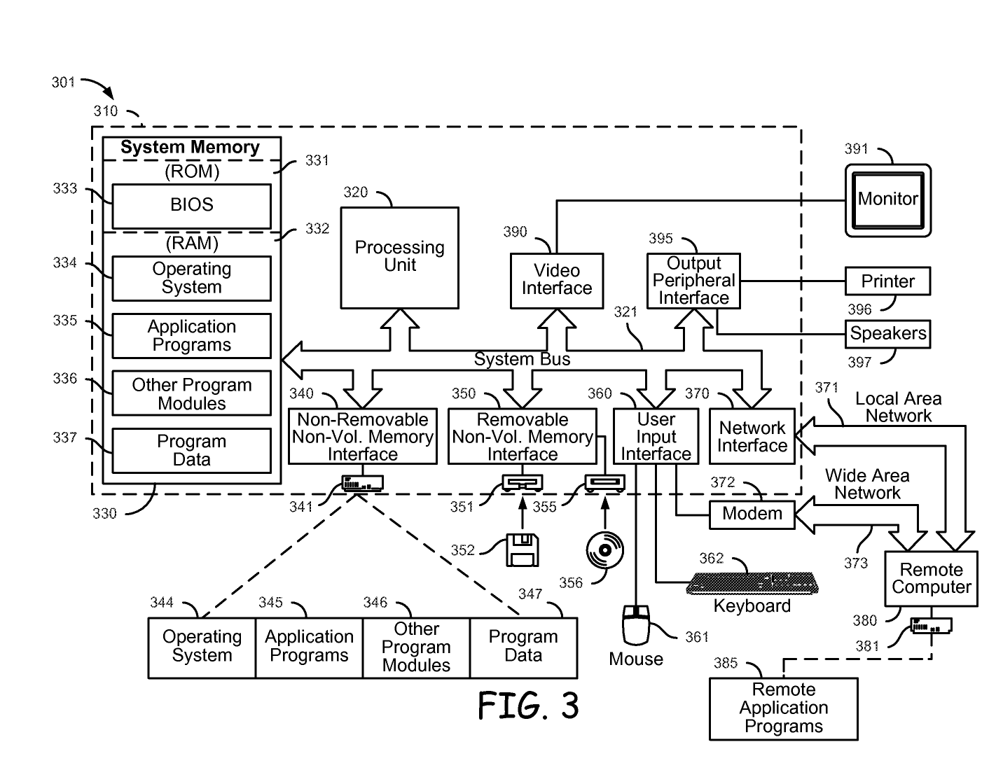

Any of the components of system 102 (e.g., web server 104, calendar application server 106, etc.) may be a processing device such as that described with respect to FIG. 3. With reference to FIG. 3, an exemplary system for implementing the technology includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 231. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

The computer 310 may also include other removable/non-removable, volatile/nonvolatile computer storage media. By way of example only, FIG. 3 illustrates a hard disk drive 340 that reads from or writes to non-removable, nonvolatile magnetic media, a magnetic disk drive 351 that reads from or writes to a removable, nonvolatile magnetic disk 152, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 320 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 390.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

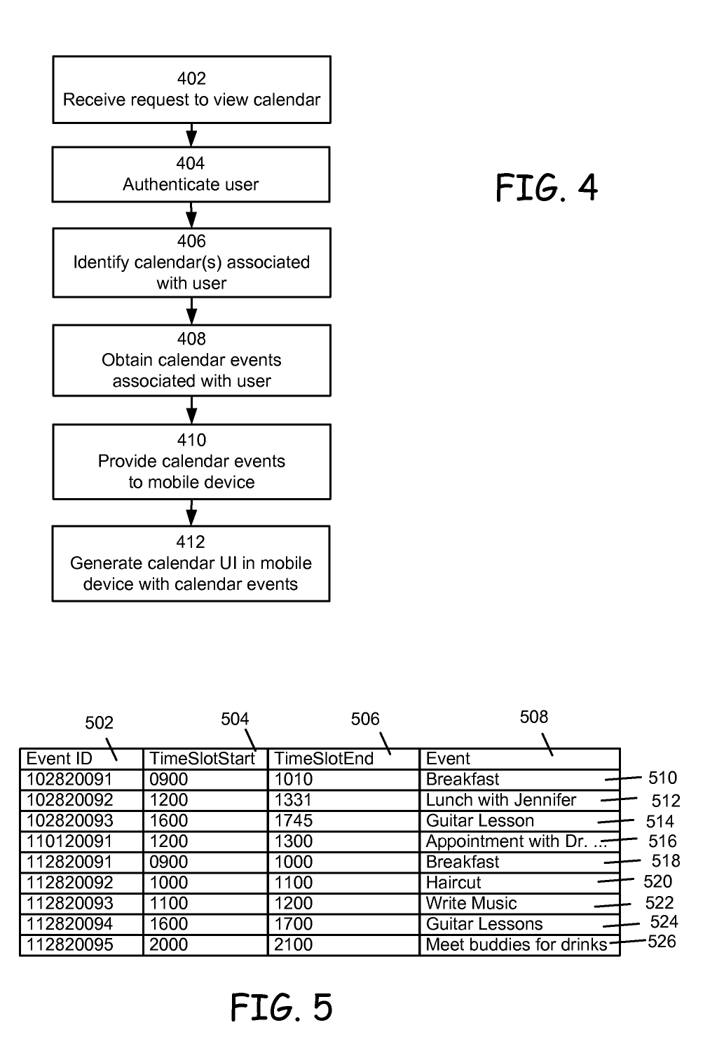

FIG. 4 illustrates exemplary steps for generating a calendar user interface (UI) in mobile device 20 with events obtained from calendar database 108. At step 402, system 102 retrieves a request from mobile device 20 to view a calendar. Using the example provided in FIG. 1, browser 22 on mobile device 20 is launched and user directs browser 22 to the landing page of the calendar application. In some embodiments, the user types in the URL to the calendar application. In other embodiments, the user selects a bookmark associated with the calendar application.

At step 404, system 102 authenticates the user. In the instance of Microsoft's Windows Live™ calendar, the user directs the Internet browser on the mobile device to the Windows Live™ home page (e.g., home.live.com). The user is requested to enter a username (e.g., Windows Live™ ID) and password in order to access Windows Live™ home page, which includes a calendar application. It is possible that the user has previously been authenticated. In this instance, calendar application server 106 automatically authenticates the user. The user is not required to reenter their username and password every time they access the web-based calendar application.

At step 406, system 102 identifies one or more calendars associated with the user. At step 408, system 102 obtains calendar records from calendar database 108 associated with each calendar identified at step 406. In one embodiment, system 102 obtains event records for events scheduled up to thirty days out (from Today). It is within the scope of the technology described herein for system 120 to obtain event records for less than thirty days out or more than thirty day out. At step 410, system 102 provides the calendar records obtained from calendar database 108 (step 408) to mobile device 20. Event records are stored in memory 262 of mobile device 20.

At step 412, mobile device 20 generates a calendar UI. The specific UI generated by mobile device browser 22 depends on several things. For example, the browser 22 may generate a default calendar UI, the user may have specified in the calendar application what the landing page should be (e.g., customized default settings). The default or customized settings may display a single day, a week or a month. In some embodiments, the default or customized calendar setting is an agenda view (e.g., only displays scheduled events).

FIG. 5 illustrates exemplary event records associated with a user. When a user schedules an event in the web-based calendar (via any device) and saves the event, an event record for the particular event is stored in calendar database 108. Each event record includes Event ID field 502, TimeSlotStart field 504, TimeSlotEnd field 506, and Event field 506. Event ID field 502 contains a unique identifier for the event. In the records shown in FIG. 5, the unique identifier is the date of the event plus a character. This identifier is exemplary only, and is not intended to limit the scope of the technology described herein. The unique identifier may be any sequence of characters. TimeSlotStart field 504 indicates the time the user set the event to begin. TimeSlotEnd field 506 indicates the time the user set the event to end. Event field 508 is the description of the event entered by the user. The time shown in TimeSlotStart field 504 and TimeSlotEnd field 506 is shown in a 24 hour clock format. It is within the scope of the technology described herein for the fields 504, 506 to contain times in a 12 hour clock format as well. These fields are exemplary only, and are not intended to limit the scope of the technology described herein. An event record may include other fields, additional fields or fewer fields.

FIG. 5 illustrates three exemplary records associated with a user (indicating that the user has scheduled nine events in the web-based calendar) for events occurring on Oct. 28, 2009. Event record 510 represents a breakfast scheduled by the user on Oct. 28, 2009 (Event ID field 502 contains 102820091) from 9:00 AM-10:00 AM (TimeSlotStart field 502 contains 0900 and TimeSlotEnd field 506 contains 1000). Event record 512 represents a lunch with Jennifer scheduled by the user on Oct. 28, 2009 (Event ID field 502 contains 102820092) from 12:00 PM-1:31 PM (TimeSlotStart field 502 contains 1200 and TimeSlotEnd field 506 contains 1331). Event record 514 represents a guitar lesson scheduled by the user on Oct. 28, 2009 (Event ID field 502 contains 102820093) from 4:00 PM-5:45 PM (TimeSlotStart field 502 contains 1600 and TimeSlotEnd field 506 contains 1745).

FIG. 5 illustrates one exemplary record associated with a user (indicating that the user has scheduled nine events in the web-based calendar) for an event occurring on Nov. 1, 2009. Event record 516 represents an appointment with Dr. Severance scheduled by the user on Nov. 1, 2009 (Event ID field 502 contains 110120091) from 12:00 PM-1:00 PM (TimeSlotStart field 502 contains 1200 and TimeSlotEnd field 506 contains 1300).

FIG. 5 also illustrates five event records associated with a user for event occurring on Nov. 28, 2009. Event record 518 represents a breakfast scheduled by the user on Nov. 28, 2009 (Event ID field 502 contains 112820091) from 9:00 AM-10:00 AM (TimeSlotStart field 502 contains 0900 and TimeSlotEnd field 506 contains 1000). Event record 520 represents a haircut scheduled by the user on Nov. 28, 2009 (Event ID field 502 contains 112820092) from 10:00 AM-11:00 AM (TimeSlotStart field 502 contains 1000 and TimeSlotEnd field 506 contains 1100). Event record 522 represents time set aside by the user to write music on Nov. 28, 2009 (Event ID field 502 contains 112820093) from 11:00 AM-12:00 PM (TimeSlotStart field 502 contains 1100 and TimeSlotEnd field 506 contains 1300). Event record 524 represents guitar lessons scheduled by the user on Nov. 28, 2009 (Event ID field 502 contains 112820094) from 4:00 PM-5:00 PM (TimeSlotStart field 502 contains 1600 and TimeSlotEnd field 506 contains 1700). Event record 526 represents time to meet buddies for drinks on Nov. 28, 2009 (Event ID field 502 contains 112820095) from 8:00 PM-9:00 PM (TimeSlotStart field 502 contains 2000 and TimeSlotEnd field 506 contains 2100).

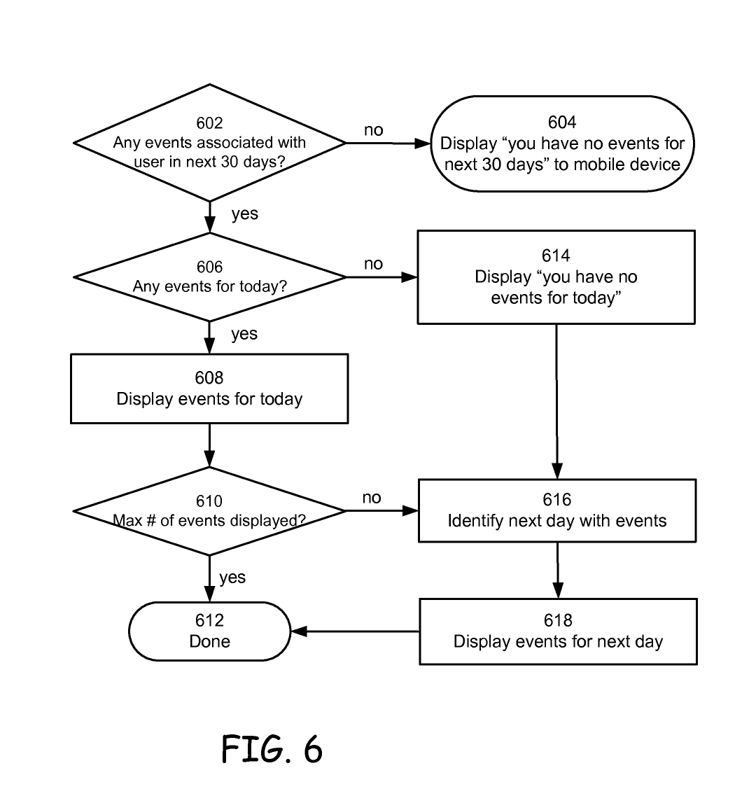

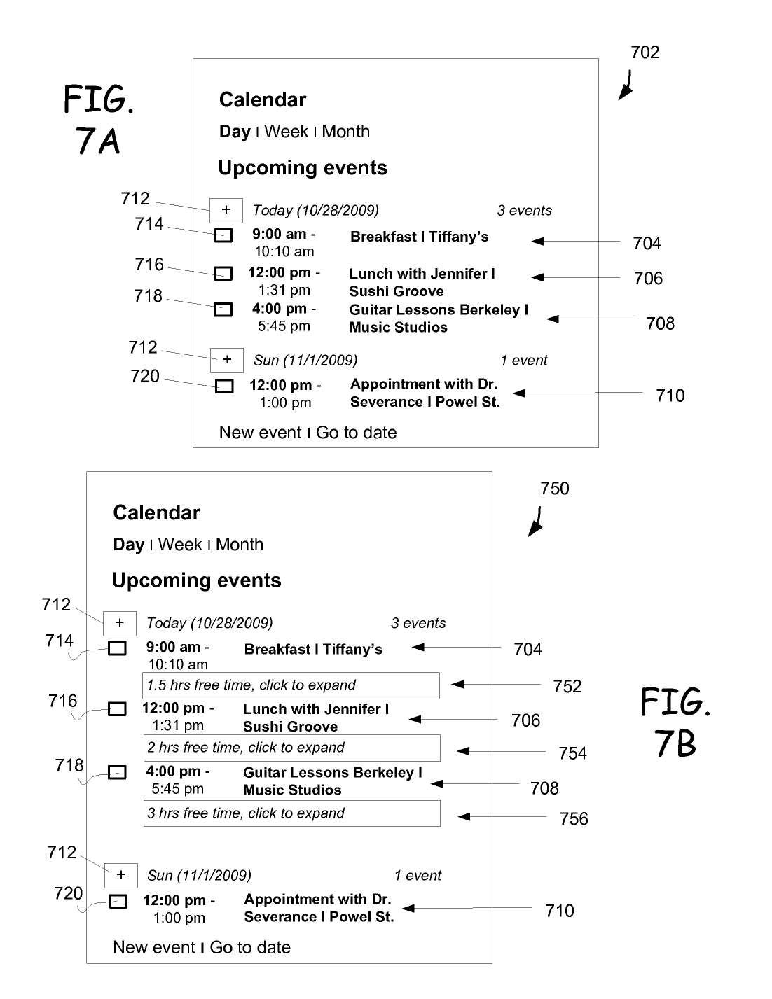

FIG. 6 is a flow chart describing one embodiment of a process for displaying web-based calendar events in a mobile device. FIG. 6 provides additional detail of step 412 shown in FIG. 4. As discussed above, the mobile device screen is small. The default calendar UI or landing page initially displayed to the user in the mobile phone screen is intended to provide a summary of events scheduled by the user in the web-based calendar application. Events scheduled for today are likely most relevant to the user. Thus, the default calendar UI initially displayed to the user in the mobile device screen displays events the events scheduled for today. If room exists in the mobile device screen, events scheduled for another day (in addition to Today) are also displayed in the mobile device screen. This way, the user can easily view the events scheduled for today and get a preview of upcoming events.

At step 602, mobile device 20 determines if there is any event records in memory 262 associated with the next thirty days. If no events are scheduled in the next thirty days, mobile device 20 displays “you have no events scheduled for the next 30 days” in the calendar UI, at step 604. Other messages may be displayed in mobile device 20. If mobile device 20 identifies at least one event record associated with the next thirty days, mobile device 20 determines whether any of the event records are associated with today, at step 606.

Mobile device 20 displays the events associated with today in the calendar UI, at step 608. Because a limited number of events may be displayed in the mobile device screen at one time, mobile device 20, at step 610, determines if a maximum number of events associated with Today are displayed in the calendar UI. The maximum number of events that may be viewed at one time in the screen of mobile device 20 is dependent on mobile device 20 itself. If a maximum number of events is being displayed in the calendar UI, mobile device 20 does not attempt to display any further events in the calendar UI (step 612).

If the maximum number of events is not being displayed in the calendar UI, mobile device 20 identifies event records associated with the next day, at step 616. The term “next day” does not necessarily refer the next chronological day (e.g., tomorrow). The term “next day” is intended to refer to the next day that has at least one event record. For example, if today is Monday, the “next day” with a scheduled event may not be Tuesday. The user may not have another event scheduled until Friday, Saturday, Sunday, the following week, and so on. At step 618, mobile device 20 displays the events associated with the next day in the calendar UI. If, for example, the events scheduled for Today are associated with Monday and the next scheduled event is not until Saturday, mobile device 20 displays the events scheduled for Today (Monday) and Saturday. The days in between with no events, Tuesday, Wednesday, Thursday and Friday, will not be displayed in the calendar UI. This initial calendar UI is referred herein to as a “collapsed day view” or “agenda view.”

When viewing a calendar, a user typically wants to know what their schedule looks like for Today. Thus, in some embodiments, the initial calendar UI always displays Today whether there are events scheduled for Today or not. In this instance, mobile device 20, when it does not identify any events for Today, at step 606, displays “you have no events for today” in calendar UI, at step 614. Mobile device 20 then proceeds to step 616, where mobile device 20 identifies the next day associated with events records stored in memory 262. Steps 618-620 are then repeated.

FIGS. 7A-7B illustrate two different embodiments of an agenda view displayed in the screen of mobile device 20. UI 702 in FIG. 7A displays three events scheduled for Today, Oct. 28, 2009: event 704: Breakfast at Tiffany's between 9:00 am-10:10 am; event 706: lunch with Jennifer between 12:00 pm-1:31 pm; event 708: guitar lessons between 4:00 pm-5:45 pm. UI 702 also displays one event scheduled for Sunday, Nov. 1, 2009: event 710: appointment with Dr. Severance between 12:00 pm-1:00 pm. Mobile device 20 generated UI 702 based on records 510, 512, 514, 516 located in memory 262. The agenda view saves the user from unnecessary scrolling to view all the events scheduled in the day. UI 702 also displays how many events are scheduled for a particular day so that a user may quickly view how bust the day will be. UI 702 also displays that “3 events” are scheduled for Today and “1 event” is scheduled for Sunday. These two event indicators allow a user to quickly and easily identify how many events they have scheduled for a particular day. With UI 702, the user is provided the extra benefit of seeing a more clear representation of the structure of their day (e.g., how packed is my day and is there any free time in between scheduled events) because the user's free time in the day is not displayed.

UI 702 displays an indicator adjacent each event. In FIG. 7A, indicator 714 is associated with event 704, indicator 716 is associated with event 706, indicator 718 is associated with event 708, and indicator 720 is associated with event 710. Each indicator, which is shown as a box in FIG. 7A, indicates the calendar that the event is associated with. As discussed above, a single user may be associated with multiple calendars. In such a situation, different color indicators may represent different calendars so that a user may identify which calendar the event belongs to. The indicators shown in FIG. 7A are exemplary, and are not intended to limit the scope of the technology described herein. An indicator may be distinguishable by having a different color, a different shape, and so on.

FIG. 7B illustrates another embodiment of an agenda view displayed in the screen of mobile device 20. UI 750 in FIG. 7B displays a condensed or collapsed view of the free time within the day in addition to the events scheduled for the day. UI 750 displays a first condensed free time slot 752, a second condensed free time slot 754 and a third condensed free time slot 756. Slot 752 displays that the user has 1.5 hours of free time between event 704 and event 706. Slot 754 displays that the user has 2 hours of free time between event 706 and event 708. As discussed above, in one embodiment, the calendar defaults to a twelve hour day, ranging from 9:00 am-9:00 pm. Thus, slot 756 displays that the user has 3 hours of free time after event 708 (representing 6:00 PM-9:00 PM). UI 750 allows a user to easily and quickly determine how many hours of free time are available between scheduled events.

Slots 752, 754, 756 do not display the exact amount of time between events. For example, slot 752 indicates that the user has 1.5 hours of free time between events 704 and 706. In real time, the user actually has 1.8 hours of free time between events 704 and 706 (1 hour 50 min). As discussed above, free time slots are for at least thirty minutes and start at the top of an hour or the bottom of an hour. Because event 704 ends at 10:10 AM, less than thirty minutes is available between 10:10 AM and 10:30 AM. Thus, system 102 skips to 10:30 AM after event 704 to calculate the amount of free time. In other embodiments, the exact amount of free time between events is displayed in a collapsed free time slot (e.g., slot 752). Using the example provided in FIG. 7B, in this embodiment, slot 752 would display “1.8 hours free, click here to expand.” The manner in displaying the amount of free time in a condensed slot shown in FIG. 7B is exemplary only, and is not intended to limit the scope of the technology described herein. The amount of free time may be displayed in any manner in a condensed free time slot. For example, condensed free time slot may also display “1:30 free time,” “1 hr 30 min free time,” and the like.

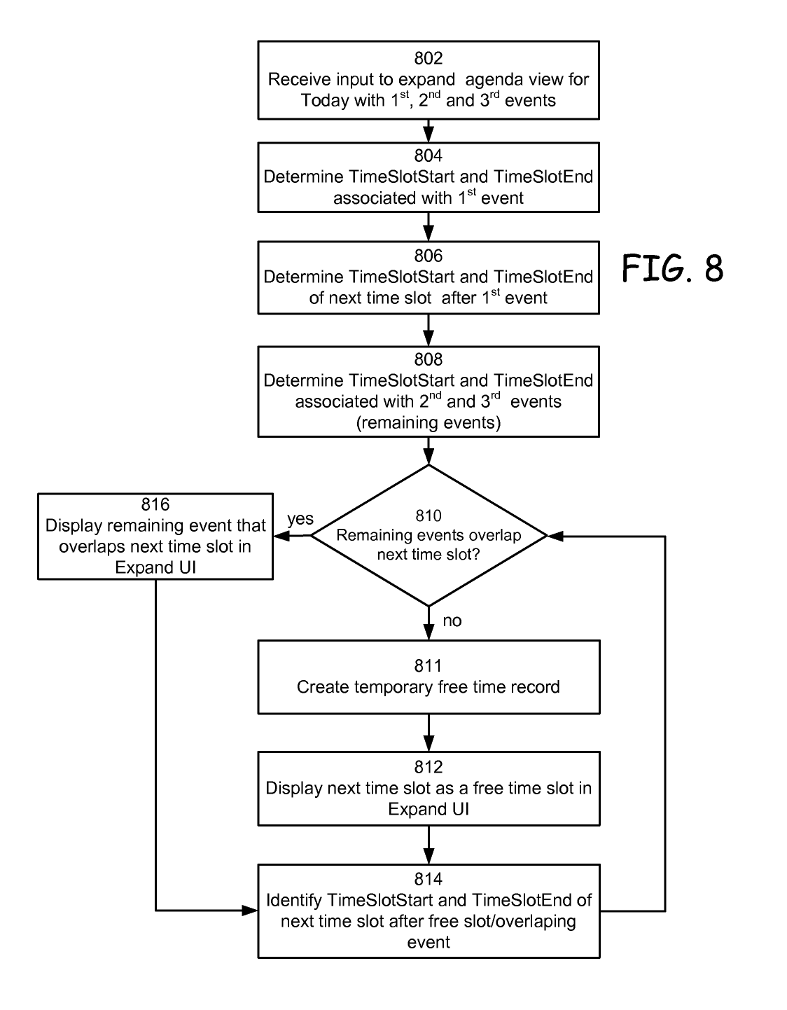

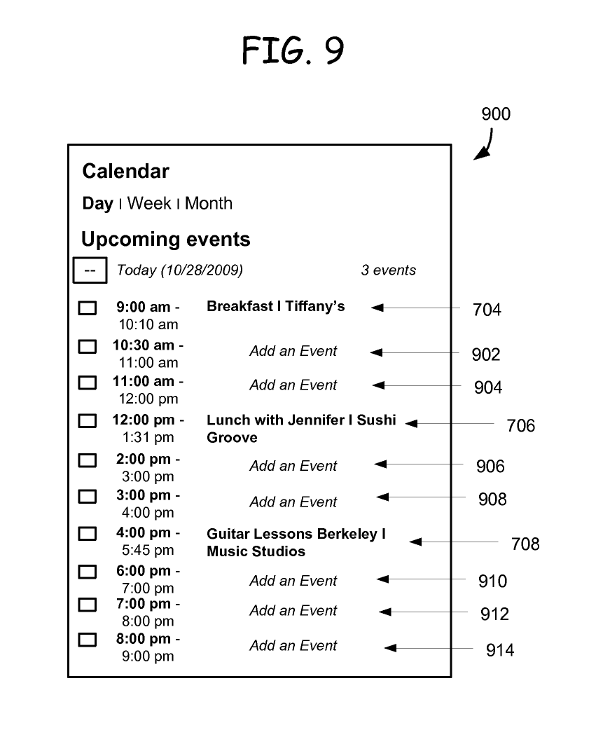

UI 702, 750 includes expand button 712. A user may select button 712 to launch another calendar view that displays both scheduled events and free time slots. A user may also select any of the condensed free time slots 752, 754, 756 to launch the calendar view displaying scheduled events and free time slots. FIG. 8 illustrates an embodiment of exemplary steps for generating an expanded calendar view upon a user selecting either slots 752, 754, 756 or button 712 shown in UI 750. An expanded calendar view (shown in FIG. 9) is a day calendar view displaying the events scheduled for the day and the remaining free time slots (if any) within the day.

A free time slot is a thirty-minute or one-hour segment of time that does not have an event scheduled during that time period. A free time slot begins and ends on the hour (e.g., :00) or half-hour (e.g., :30). In some embodiments, a free time slot may consist of any length of time and may start and end at any time. In some embodiments, a default day in the calendar application consists of a twelve hour day beginning at 9:00 AM (“start of the day”) and ending at 9:00 PM (“end of the day”). A user may customize the default start of the day and end of the day to fit their own schedule (e.g., set a day to start at a time other than 9:00 AM and/or end at a time other than 9:00 PM) and may expand or shorten the default length of a day in the calendar application (e.g., a day is more or less than twelve hours). A user may schedule an event in the calendar prior to the default start of the day or after the default end of the day. For example, a user may schedule a one-hour event in the calendar that starts at 6:00 AM even though the default start of the day is 9:00 AM.

At step 802, mobile device 20 receives input to expand the collapsed view shown in, for example, FIG. 7A, into an expanded calendar view (see FIG. 9). In some embodiments, the input received at step 802 is based on a user selecting one of the free time slots 752, 754, 756 shown in FIG. 7B. In other embodiments, the input received at step 802 is based on a user selecting button 712 shown in FIGS. 7A-7B associated with a particular day.

Using the event records shown in FIG. 5, system 102, at step 804, determines TimeSlotStart field 502 and TimeSlotEnd field 504 for the first event of Today, event 704. This information is stored in record 510, which represents the first event of the day, event 704. System 102 determines that TimeSlotStart field 502 is 0900 and TimeSlotEnd field 504 is 1010 in record 512.

At step 806, system 102 determines TimeSlotStart field 502 and TimeSlotEnd field 504 of the time slot following event 704. As discussed above, time slots are either thirty-minute or one-hour periods of time and begin and end at the top of an hour or the bottom of the hour. System 102, at step 804, identified that event 704 ends at 10:10 AM. Because a time slot is either thirty minutes or one hour and starts at the top or bottom of an hour, system 102 identifies that the next time slot begins at 10:30 AM (TimeSlotStart field 502 is 1030). It is within the scope of the technology described herein for the next time slot to begin immediately after the end of event 704. Also, because the next time slot begins at the bottom of an hour, system 102, to maximize the number of time slots in the day, determines that the time slot will be a thirty-minute time slot and end at 11:00 AM (TimeSlotEnd field 504 is 1100). A temporary record is created for this time slot (10:30 AM-11:00 AM) and stored in database 108.

At step 808, system 102 determines TimeSlotStart field 502 and TimeSlotEnd field 504 for each of the two remaining events scheduled for Today, events 706, 708. System 102 identifies the two remaining events for Today by identifying events records 512, 514. System 102 determines TimeSlotStart field 502 and TimeSlotEnd field 504 for records 512, 514. For record 512, TimeSlotStart field 502 is 1200 and TimeSlotEnd field 504 is 1331. For record 514, TimeSlotStart field 502 is 1600 and TimeSlotEnd field 504 is 1745.

At step 810, system 102 determines if either of the two remaining events, events 706. 708, overlap in time with the time slot from 10:30 AM-11:00 AM. System 102 makes this determination by comparing TimeSlotStart field 502 and TimeSlotEnd field 504 of each of records 512, 514 against the temporarily created record for 10:30 AM-11:00 AM. Using the records shown in FIG. 5, events 706, 708 do not overlap in time with the time slot from 10:30 AM-11:00 AM. System 102 therefore creates a temporary free time record associated with the time slot and provides the temporary record to mobile device 20, at step 811. The temporary record is stored in memory 262 of mobile device 20. Mobile device 20 displays the 10:30 AM-11:00 AM time slot in the calendar UI as a free time slot in the expanded calendar view (see time slot 902 in FIG. 9), at step 812. If either of events 704, 706 overlap in time with the 10:30 AM-11:00 AM time slot, mobile device 20 displays the overlapping event in the calendar UI.

System 102 determines TimeSlotStart field 502 and TimeSlotEnd field 504 of the time slot following the 10:30 AM-11:00 AM time slot, at step 814. In the embodiment whereby a time slot is either a 30 min or 1 hr time slot, system 102 identifies that the next time slot after 10:30 AM-11:00 AM is a 1 hr time slot (because it starts at the top of an hour), and is 11:00 AM-12:00 PM. System 102 creates a second temporary record representing 11:00 AM-12:00 PM (e.g., TimeSlotStart field 502 is 1100, TimeSlotEnd Field 504 is 1200). Step 810 is repeated by comparing TimeSlotStart field 502 and TimeSlotEnd field 504 of records 512, 514 against TimeSlotStart field 502 and TimeSlotEnd field 504 of the second temporary record. Because events 704, 706 do not overlap in time with 11:00 AM-12:00 PM, system 102 provides the second temporary record to mobile device 20, and mobile device 20 displays the time slot 11:00 AM-12:00 PM as free, at step 812. When an event overlaps in time with the next time slot of the day, system 102 provides instructions to mobile device 20 to display the scheduled event, at step 816. Steps 810-816 are repeated until system 102 determines that all the time slots for the day (e.g., 9:00 AM-9:00 PM) are either free or associated with an event.

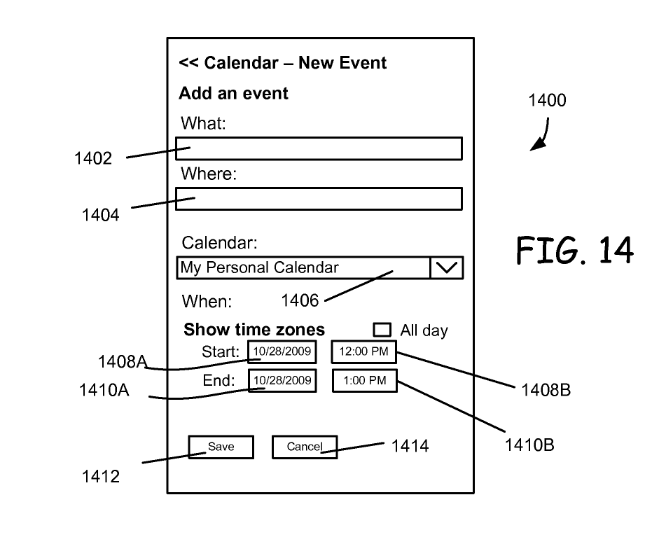

FIG. 9 illustrates an embodiment of an expanded calendar view 900 displayed in a mobile device screen. Expanded calendar view 900 was generated because the user either selected button 712 associated with Today or selected slots 752, 754 or 756 shown in FIG. 7B. Expanded calendar view 900 displays every time slot associated with Today. View 900 displays the three events the user has scheduled for Today, Oct. 28, 2009 (events 704, 706, 708), as well as a free time slot for each the remaining time slots of the day that does not have a scheduled event. Expanded calendar view 900 displays the three scheduled events 704, 706, 708 from the agenda view and seven free time slots 902, 904, 906, 908, 910, 912 and 914. Each of the free time slots may be selected to launch a new event interface (shown in FIG. 14) that allows a user to schedule a new event for the selected time slot. This feature saves the user from unnecessary data entry when scheduling a new event (to be discussed in more detail later).

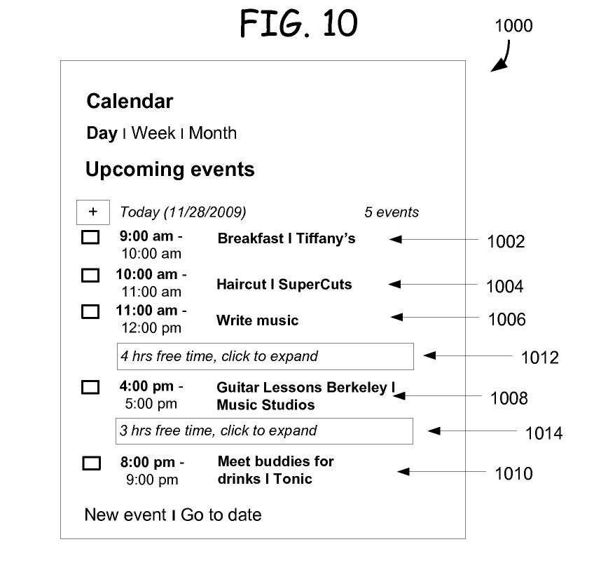

FIG. 10 displays another agenda view 1000. Agenda view 1000 displays five events scheduled for Today, which is now Nov. 29, 2009. Event 1002 is breakfast scheduled from 9:00 AM-10:00 AM, event 1004 is a haircut scheduled from 10:00 AM-11:00 AM, event 1006 is time reserved to write music from 11:00 AM-12:00 PM, event 1008 is guitar lessons scheduled for 4:00 PM-5:00 PM, and event 1010 is time to meet buddies for drinks from 8:00 PM-9:00 PM. Agenda view 1000 also displays two collapsed free time slots 1012, 1014, each represented by a temporary record. Slot 1012 displays to the user that there are four hours of free time between event 1006 and event 1008. Slot 1014 displays to the user that there are three hours of free time between events 1008 and 1010. System 102 created an event record for events 1002, 1004, 1006, 1008, 1010 when scheduled by the user in the calendar application. Each event record is stored in database 108.

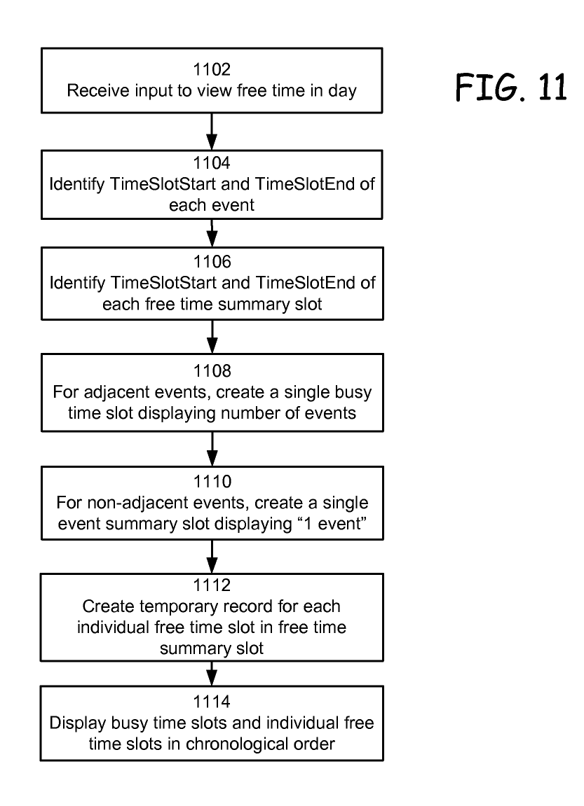

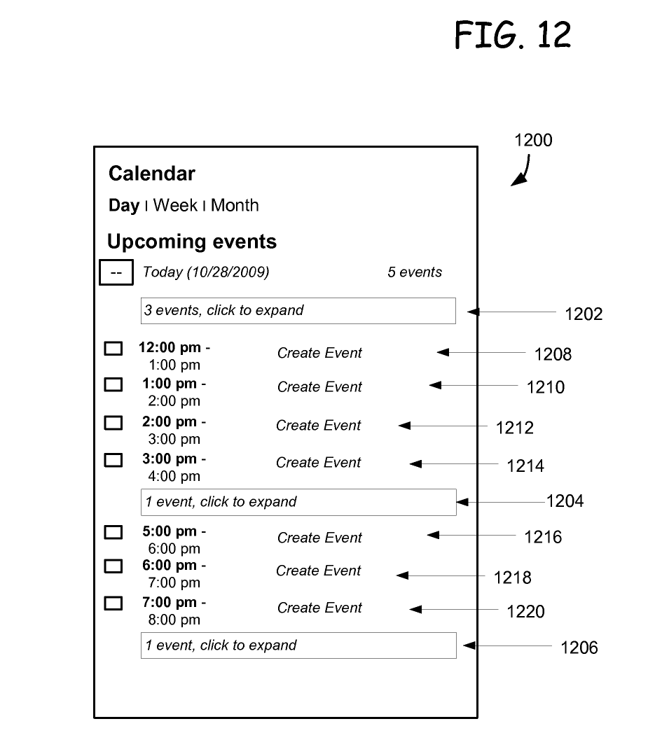

FIG. 11 displays exemplary steps executed by system 102 to generate a collapsed event view 1200 (shown in FIG. 12) that displays scheduled events in a collapsed view based on the agenda view 1000 shown in FIG. 10. Collapsed event view 1200 displays each individual free time slot and consecutively scheduled events as a single time slot. At step 1102, system 102 receives input that a user would like to view the collapsed event view 1200. In one embodiment, a user selects a collapsed busy view from a drop-down menu in the calendar UI (not shown). Any other method for selecting the collapsed busy view is within the scope of the technology described herein (e.g., select button similar to button 712, etc.).

At step 1104, system 102 identifies TimeSlotStart field 502 and TimeSlotEnd field 504 for each scheduled event. Using the records shown in FIG. 5, system 102 identifies event records 518, 520, 522, 524, 526 representing events 1002, 1004, 1006, 1008, 1010 respectively. At step 1104, system 102 identifies TimeSlotStart field 502 and TimeSlotEnd field 504 in each event record 518, 520, 522, 524, 526. TimeSlotStart field 502 is 0900 and TimeSlotEnd field 504 is 1000 for event record 518. TimeSlotStart field 502 is 1000 and TimeSlotEnd field 504 is 1100 for event record 520. TimeSlotStart field 502 is 1100 and TimeSlotEnd field 504 is 1200 for event record 522. TimeSlotStart field 502 is 1600 and TimeSlotEnd field 504 is 1700 for event record 524. TimeSlotStart field 502 is 2000 and TimeSlotEnd field 504 is 2100 for event record 526.

At step 1106, system 102 identifies TimeSlotStart field 502 and TimeSlotEnd field 504 of each condensed free time slot 1012, 1014 in the agenda view 1000 shown in FIG. 10. For slot 1012, system 102 identifies 1200 in TimeSlotStart field 502 and 1600 in TimeStartEnd field 504 in the temporary record. For slot 1014, system 102 identifies 1700 in TimeSlotStart field 502 and 2000 in TimeStartEnd field 504 in the temporary record.

At step 1108, system 102 creates a temporary record to represent the collapsed busy time slots. Using the example shown in FIG. 10, system 102 identifies that events 1002, 1004, 1006 are adjacent (or consecutive) time slots with a scheduled event. System 102 creates a single collapsed busy time slot (slot 1202 in FIG. 12) that represents events 1002, 1004, 1006. Slot 1012 is associated with a temporary record, stored in database 108, with 900 in TimeSlotStart field 502 and 1200 in TimeSlotEnd field 504.

The two remaining events 1008, 1010 in the day are not adjacent to each other or another event. Events 1008, 1010 are each a single event surrounded by free time. Thus, at step 1110, system 102 creates two temporary records, one for each condensed busy time slot created for each event 1008, 1010. As will be shown later with reference to FIG. 12, a collapsed busy time slot displays the number of events associated with the slot.

At step 1112, system 102 creates a temporary record for each individual time slot within a condensed free time slot (slots 1012, 1014 in FIG. 10). As disclosed above, a free time slot begins at the top of an hour or the bottom of an hour. If a time slot starts at the bottom of the hour, the time slot is a thirty-minute time slot. If the time slot begins at the top of an hour, the time slot is a one hour time slot. Using the agenda view shown in FIG. 10, system 102 creates four temporary one-hour records associated with slot 1012. System 102 also creates three temporary one-hour records associated with slot 1014. System 102 provides these temporary records to mobile device 20, which stored the records in memory 262. At step 1114, mobile device 20 displays the condensed busy time slots created at steps 1108, 1110, and the individual free time slots associated with the temporary records created at step 1112, in the calendar UI (see FIG. 12).

FIG. 12 illustrates an exemplary calendar UI 1200 displaying a collapsed busy time view. UI 1200 displays three condensed busy time slots 1202, 1204, 1206. Condensed busy time slot 1202 displays the number of events included in time slot 1202 (3 events) and indicates that slot 1202 may be expanded by clicking on it. Condensed time slots 1204, 1206 display the number of events included in the time slot (1 event) and indicate that the time slot 1204, 1206 may be expanded by clicking on it. UI 1200 also displays each individual free time slot 1208, 1210, 1212, 1214, 1216, 1218, 1220. Each free time slot displays the time covered by the slot and is selectable by the user in order to schedule an event for that particular time. UI 1200 allows a user to quickly and easily view what time of the day the user is busy and what time of the day the user has free.

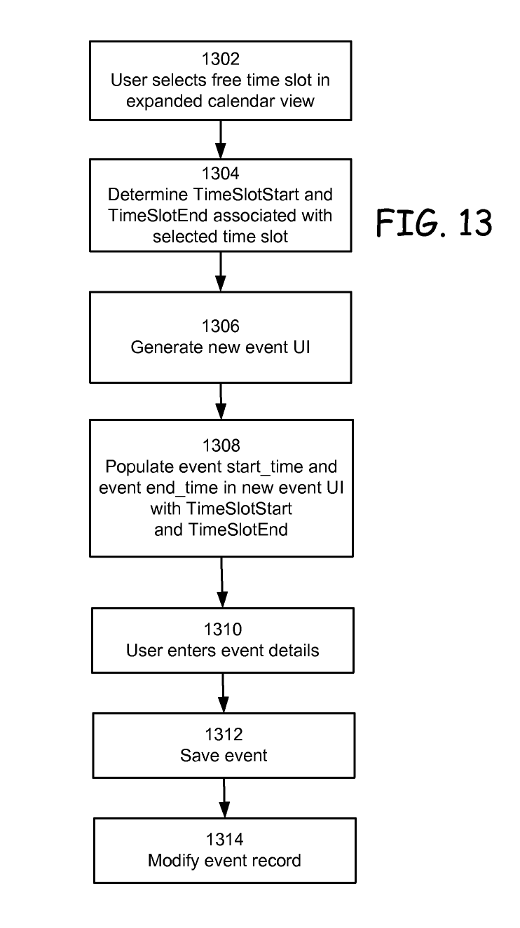

FIG. 13 illustrates exemplary steps for scheduling an event based upon a user selecting one of the free time slots displayed in UI 1200 shown in FIG. 12. At step 1302, the user selects a free time slot displayed in the expanded calendar view. For example, using the UI 1200 shown in FIG. 12, suppose the user selects free time slot 1208. At step 1304, system 102 determines TimeSlotStart field 502 and TimeSlotEnd field 504 in the record associated with free time slot 1208. In this case, system 102 determines that TimeSlotStart field 502 is 1200 and TimeSlotEnd field 504 is 1300. At step 1306, mobile device 20 generates a new event UI 1400 (shown in FIG. 14). As will be discussed in more detail later, UI 1400 includes, among other things, a start time and end time for the event. At step 1308, system 102 provides to mobile device 20 TimeSlotStart field 502 (1200) and TimeSlotEnd field 504 (1300) and mobile device 20 populates the start time and end time in the new event UI 1400 with 12:00 PM and 1:00 PM (if events are set on a 12 hour clock). It is also within the scope of the technology described herein for events to be scheduled according to a 24 hour clock. In that case, the end time of the new event would be displayed as 13:00.

FIG. 14 provides an embodiment if new event UI 1400. UI 1400 includes a What field 1402, Where field 1404, Calendar field 1406, Start fields 1408A, 1408B and End field 1410A, 1410B. FIG. 14 illustrates that the start fields 1408A, 1408B are populated with the date and time associated with the selected free time slot 1208. This is a time saving feature as the user does not have to enter the date and time information into UI 1400. The information is populated in UI 1400 simply by selecting the free time slot 1208.

Returning to FIG. 13, a user may schedule an event in the web-based calendar for the time associated with free time slot 1208 by entering a description in field 1402 and Where field 1404, at step 1310. At step 1312, the event may be saved by selecting save button 1412. Upon selecting save button 1412, system 102 creates an event record similar to the records shown in FIG. 5 for the newly scheduled event. If the user chooses not to schedule an event for the date and time frame shown in start fields 1408A, 1408B and end fields 1410A, 1410B, the user may select the cancel button 1414 to exit UI 1400.

A user can also modify the dates and times shown in start fields 1408A, 1408B and end fields 1410A, 1410B. The user may select the start field 1408A to change the start date of the event. The user may select start field 1408B to change the start time of the event. The user may select the end field 1410A to change the end date of the event. The user may select end field 1410B to change the end time of the event.

Each event may be scheduled in the web-based calendar via many different devices. For example, one or more events may be scheduled by the user in the web-based calendar via their desktop computer or laptop computer. In other embodiments, as will be described in more detail later, the user may schedule the event in the web-based calendar via their mobile phone. Regardless of how the events are scheduled, the calendar application in the mobile phone synchronizes with the web-based calendar stored in the calendar application server 106. In some embodiments, the synchronization occurs periodically and events are stored in memory in the mobile phone. In other embodiments, synchronization does not occur until the calendar application in the mobile phone requests calendar events.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A computer implemented method for enabling a mobile device to display a calendar view displaying free time within a day of the week consisting of a plurality of time slots, comprising:
(a) receiving input from the mobile device indicating that a user of the mobile device wants to view a calendar displaying the free time the user has within a selected day;
(b) identifying event records associated with the calendar for the selected day, wherein the event records are stored in a database;
(c) determining remaining time slots associated with the selected day that are not associated with a scheduled event;
(d) automatically generating a temporary free-time record for each time slot determined in step (c);
(e) automatically generating one or more temporary event summary records representing the events identified in step (b); and
(f) delivering the temporary free-time records generated in step (d) and the temporary event summary records generated in step (e) to the mobile device.

2. The method as recited in claim 1, wherein step (e) of generating one or more temporary event summary records comprises:
when two or more events records are identified in step (b) that represent consecutively scheduled events, generating a single temporary event summary record representing the consecutively scheduled events.

3. The method as recited in claim 1, wherein step (e) of generating one or more temporary event summary records comprises:
for each event record identified in step (b) representing a solo event, generating a single temporary event summary record representing the solo event.

4. The method as recited in claim 1, further comprising:
displaying a free time slot associated with each free-time record in a calendar user interface; and
displaying a condensed busy time slot associated with each busy time record generated in step (e) in a calendar user interface.

5. The method as recited in claim 1, wherein step (a) of receiving input comprises:
electronically receiving a request from the mobile device for event records associated with the user, wherein the event records are stored in a database.

6. The method as recited in claim 2, wherein the step of generating a single temporary event summary record representing the two or more consecutive events comprises:
identifying a first event record and a second event record representing a first event followed by a second event, the first and second event records each having a start time and an end time; and
generating a temporary event summary record, the temporary event summary record having a start time of the first event record and an end time of the second event record.

7. The method as recited in claim 6, wherein the temporary event summary record further includes the number of events represented by the event summary record.

8. The method as recited in claim 1, further comprising:
receiving a new event record from the mobile device; and
storing the new event record in the database.

9. The method as recited in claim 9, wherein the new event record is generated by the mobile device when a free time slot displayed by the mobile device selected by the user, the free time slot displayed in the mobile device is based on a free-time record delivered in step (f).

10. A method for delivering calendar events records to a mobile device, comprising the steps of:
(a) receiving a request from a mobile device for a condensed busy time view of a selected day;
(b) identifying one or more calendars associated with the user;
(c) obtaining event records associated with each of the one or more calendars identified in step (b) for the selected day, wherein each event record is stored in a database;
(d) generating a temporary free time record for each time slot of the selected day not associated with an event record obtained in step (c);
(e) generating temporary event summary records based on the event records obtained in step (c); and
(f) delivering the temporary free time records generated in step (d) and the temporary event summary records generated in step (e) to the mobile device.

11. The method as recited in claim 10, wherein step (b) of identifying one or more calendars comprises:
determining a unique identifier associated with the user; and
identifying one or more calendars associated with the unique identifier.

12. The method as recited in claim 10, wherein step (a) of receiving a request from a mobile device comprises:
receiving a request from a web browser of the mobile device.

13. The method as recited in claim 10, wherein step (d) of generating a temporary free time record for each time slot of the selected day not associated with an event record comprises:
determining a start time and end time for each event record obtained in step (c);
generating a temporary one-hour free time record for a time slot following an event associated with an event record that has an end time at the top of an hour; and
generating a temporary thirty-minute free time record for a time slot following an event associated with an event record that has an end time at the bottom of an hour.

14. The method as recited in claim 13, wherein step (e) of generating temporary event summary records comprises:
determining two or more event records for consecutively scheduled events, each event record having a start time and an end time;
generating a single temporary event summary record having the start time of the earliest event and an end time of the latest event;

15. The method as recited in claim 14, wherein consecutively scheduled events are a first event and a second event with less than thirty minutes between the end time of the first event and the begin time of the second event.

16. A system for enabling a mobile device, displaying an agenda view of a day in a calendar user interface, to display the free time remaining within the day, comprising:
a web server for receiving a request from the mobile device to view the free time remaining within the day;
a calendar application server configured to:
(a) identify first and second event records associated with the agenda view being displayed by the mobile device, wherein the first and second event records include a start time and a stop time;
(b) determine free time slots associated with the selected day that do not overlap in time with the first and second event records identified in step (a);
(c) for each free time slot determined in step (b), automatically generate a temporary free-time record;
(d) automatically generate one or more temporary event summary records based on the event records identified in step (a); and
(e) deliver the temporary free-time records generated in step (c) and the temporary event summary records generated in step (d) to the mobile device; and
a calendar database for storing the first and second event records.

17. The system as recited in claim 16, wherein the calendar application server determines free time slots associated with the selected day by:
determining a start time and a stop time for the first and second event records;
identifying the start time of the next time slot based on the stop time of the first event record;
determining a length of time of the next time slot based on when the next time slot begins; and
determining whether the second event record overlaps in time with the next time slot.

18. The system as recited in claim 17, wherein the calendar application server generates a temporary free-time record by:
when the second event record does not overlap in time with the next time slot, generate a temporary free-time record associated with the next time slot.

19. The system as recited in claim 18, wherein the calendar application server determines a length of time of the next time slot based on when the next time slot begins by:
when the next time slot begins at the bottom of an hour, generate a temporary free-time record representing a thirty-minute time slot; and
when the next time slot begins at the top of an hour, generate a temporary free-time record representing a one-hour time slot.

20. The system as recited in claim 16, wherein the calendar application server generates one or more temporary event summary records by:
determining two or more event records for consecutively scheduled events, each event record having a start time and an end time; and
generating a single temporary event summary record having the start time of the earliest event and an end time of the latest event.
